(19) United States
(12) Patent Application Publication
(10) Pub. No.: US 2013/0166998 A1
(43) Pub. Date: Jun. 27, 2013

(54) Geographically-referenced Video Asset Mapping

(71) Applicant: Patrick Sutherland, West Orange, NJ (US)

(72) Inventor: Patrick Sutherland, West Orange, NJ (US)

(21) Appl. No.: 13/719,657

(22) Filed: Dec. 19, 2012

Related U.S. Application Data
(60) Provisional application No. 61/579,745, filed on Dec. 23, 2011.

(51) Int. Cl. G06F 17/22

(52) U.S. Cl. CPC G06F 17/2247
USPC 715/202

(57) ABSTRACT

This describes a method of mapping community assets by displaying geographically-referenced, informational videos. A user selects a geographic location and receives a representative map of the selected location from a proprietary website. This map is displayed on their video screen by a web browser, overlaid with a number of entity markers, each of which represents a place of interest related to the selected location. These markers include the geographically nearest of a group of different types of entities, including the nearest ATM, the nearest gas station, the nearest source of food and drink, the nearest medical facility, the nearest educational facility and the nearest public building. The map is scaled to ensure that all the markers are displayed at a position that corresponds closely to the physical location of the entity they represent. The user selects a marker and views a video containing information relevant to that place of interest.

### CLAIM OF PRIORITY

This application claims priority to U.S. provisional patent application 61/579,745 filed on Dec. 23, 2011, the contents of which are hereby included by reference in their entirety.

### FIELD OF THE INVENTION

The invention relates to methods and systems for displaying informational videos, and more particularly, to community asset-mapping by displaying geographically-referenced informational videos.

### BACKGROUND OF THE INVENTION

Streaming videos over the Internet has become commonplace ever since high bandwidth communication networks became widely, and relatively cheaply, available, as evidenced by the success of websites such as YouTube and services such as NetFlix's steaming feature length movies.

Many business, service providers, municipal entities and charities could benefit from using informational videos to promote themselves, but are limited by not having a convenient way to reach the attention of an audience. This is particularly true of businesses such as non-chain restaurants and public entities such as township recreational departments that provide a local service requiring people to actually visit them. The Internet tends to be too global. Besides, having an informational video linked to their website is not very effective in generating new customers as people already have to know about the restaurant or service, or already be searching for it, to find the website and their videos.

The present invention overcomes this problem by aggregating informational videos from a variety of interested parties around a geographical location. This allows a user to get a quick overview of what is available in a given community by simply specifying the name or location of the community. Furthermore, by linking each service provider's promotional video to a map showing their physical location, a user can easily identify which providers are most convenient for them to visit.

The present invention has the added benefit of encouraging people to “shop local” for both goods and services. By reducing peoples travelling, fuel consumption may be reduced with all the accompanying benefits for the environment, both locally and globally.

### DESCRIPTION OF THE RELATED ART

The relevant prior art involving displaying informational videos related to a geographic location includes:

US Patent Application no. 20100241944 filed by A. Athsani et al. and published on Sep. 23, 2010 entitled “Method and Apparatus for Associating Advertising Content with Computer Enabled Maps” that describes a computer based system and method for mobile and online Internet type advertising that includes advertisements in “tag maps”, which are interactive maps with associated text strings. The system allows advertisers to buy, lease or bid in real time for advertising opportunities associated with particular tags (text strings) within such tag maps. This is in the context of Internet web pages. This further allows advertisers to modify the display or content of the associated tag maps and/or advertising units.

US Patent Application no. 20080086368 filed by S. Bauman et al. and published on Apr. 10, 2008 entitled “Location Based, Content Targeted Online Advertising” that describes an online advertisement is targeted to a publication medium (e.g., a website) based on a location of a user visiting the website, the content of the website and/or a location associated with the website content. Static and/or dynamic maps can be presented with the targeted advertisements on the website. The targeted advertisements can include a click-to-call link and/or other features for allowing a user to interact with and explore the targeted advertisement.

U.S. Pat. No. 8,010,628 issued to Finlaw on Aug. 30, 2011 entitled “Software to provide geographically relevant website content” that describes an Internet based software application that identifies the geographic location of each a website visitor by their IP address to provide geographically relevant content to each individual visitor in a customized web page. In an embodiment, content can be further customized by web page viewing patterns of users in similar geographic locations. In an embodiment the software application matches the visitor's location to likely travel departure points with offerings likely to interest a visitor from said location and displays likely attractive offers dynamically to that visitor.

U.S. Pat. No. 7,865,306 issued to Mays on Jan. 4, 2011 entitled “Devices, methods, and systems for managing route-related information” that describes a method that includes, for a predetermined route, automatically processing a first set of machine instructions to create a visual travel guide for the predetermined route, the visual travel guide comprising a second set of machine instructions adapted to cause an information device to render: an identification of a destination of the predetermined route; a plurality of videos, each video corresponding to a road intersection located approximately on the predetermined route, each video adapted to substantially reproduce a view of a driver of an automobile approaching the road intersection; a plurality of textual descriptions associated with the plurality of videos; at least one of an identification of an origin of the predetermined route and an identification of an approach to the destination; and an advertisement associated with at least a portion of the predetermined route.

Various implements are known in the art, but fail to address all of the problems solved by the invention described herein. One embodiment of this invention is illustrated in the accompanying drawings and will be described in more detail herein below.

### SUMMARY OF THE INVENTION

The present invention relates to methods and systems for community asset mapping through a geographically-referenced display of informational videos.

In a preferred embodiment, a video display device may run a web browser software package in order to connect to a proprietary website. The connection may, for instance, be via a network such as, but not limited to, an Internet connection.

A user, or operator, may then select a geographic location. The geographic location may, for instance, be a town name, a zip code, coordinates of latitude and longitude or some combination thereof. The user may, for instance, use the video display device to make the selection.

The video display device may then use the web browser to display a representative map of the selected geographic location on its video display screen.

In a preferred embodiment, the display of the map may be overlaid with a number of entity markers. These entity markers may, for instance, be some symbol such as, but not limited to, a flag, a triangle, a dot, or some combination thereof. Each of the entity markers may be indicative of a place of interest related to the geographic location that has been selected.

The overlay may display entity markers that may include those geographically nearest to the selected location of a group of different types of entities that may be of interest to a user. In a preferred embodiment this group of entities may include the nearest retail facility or ATM machine, the nearest auto facility, the nearest restaurant or source of food and drink, the nearest health facility, the nearest educational facility and the nearest public or municipal building.

In order to display the nearest example of one of each of this group, the web browser software package may need to scale the representative map so that all of the entity markers may be displayed simultaneously such that each of the entity markers may be displayed at the position on the map that corresponds to the physical location of the place of interest it is associated with, i.e., the place of interest it is indicative of.

The user may then select one of the entity markers and view an informational video containing information relevant to the selected place of interest indicated by the entity marker. The selected place of interest may be within the map and/or within an individual business or municipal result page.

The video may be a short slide show, such as a three slide preview, or it may be a full video describing the place of interest within the map and/or within the individual business or municipal result page.

Therefore, the present invention succeeds in conferring the following, and others not mentioned, desirable and useful benefits and objectives.

It is an object of the present invention to provide a website that aggregates access to a diverse collection of informational videos around a geographic location.

It is an object of the present invention to provide a means for a community to showcase its public and private assets using informational videos.

It is another object of the present invention to provide a way for a user to quickly and easily identify places of interest in, or in the vicinity of, a geographic location.

It is another object of the present invention to provide a way for businesses and events to advertise to a wide range of potential customers in the surrounding vicinity using informational videos.

It is another object of the present invention to provide a method for community asset mapping through a geographically-referenced display of informational videos, comprising: providing a video display device running a web browser software package 120 that is connected to a proprietary website via an Internet connection; selecting a geographic location using said video display device by an operator; displaying a representative map of said selected geographic location by said web browser software package on a video display screen connected to said video display device; overlaying said representative map with a plurality of entity markers, each being indicative of a place of interest related to said geographic location, said entity markers including the geographically nearest to said geographic location of at least one ATM, one gas station, one source of food and drink, one health facility, one educational facility and one public or municipal building; adjusting, by said web browser software package 120, the scale of said representative map such that all of said entity markers are displayed simultaneously and each of said entity markers is displayed at substantially the position on said representative map that corresponds to a physical location said place of interest of which said entity marker is indicative; selecting by said operator, one of said entity markers; and displaying an informational video on said video display screen containing information relevant to said selected place of interest of which said entity marker is indicative.

### BRIEF DESCRIPTION OF THE DRAWINGS

FIG. 1 shows a schematic overview of a system for implementing the community asset mapping through geographically-referenced informational videos of this invention.

FIG. 2 shows a schematic view of a page displaying a map overlaid with entity markers indicative of the availability of an informational video related to place of interest at that geographic location.

FIG. 3 shows a schematic view of a frame of an informational video accessed via the method of this invention.

FIG. 4 shows a flowchart of some of the steps in using the method of this invention.

FIG. 5 shows an example of a first page of an informational video displayed in accordance with the method of this invention.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

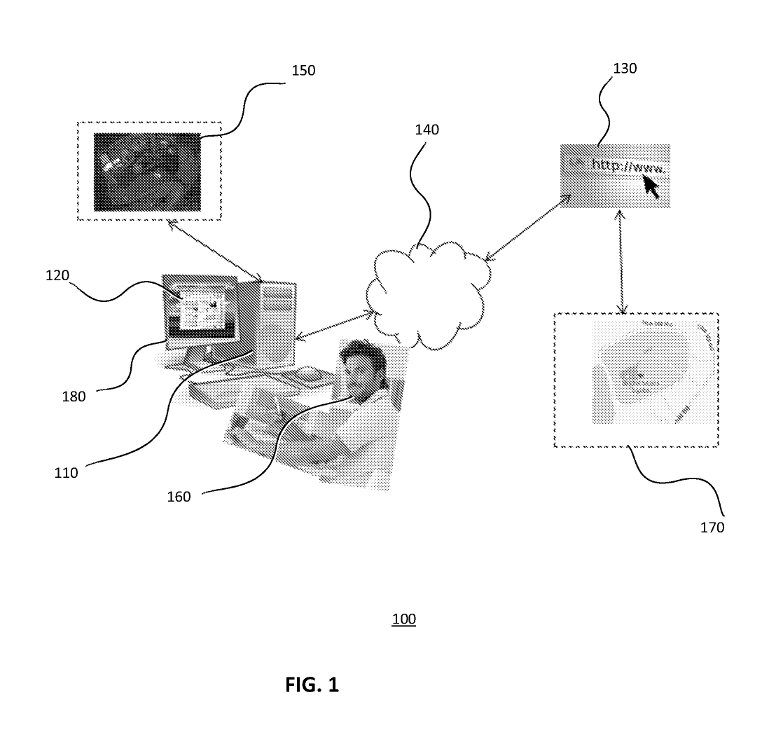

FIG. 1 shows a schematic overview of a system for implementing the community asset mapping through geographically-referenced informational videos of this invention.

As shown in FIG. 1, a user, or operator, 160 may use a video display device 110 having a video display screen 180 access a proprietary website 130. Access to the proprietary website 130 may be through a suitable network such as, but not limited to, an Internet connection 140, a wireless cellular network, a cable network or some combination thereof.

Using a web browser software package 120, or other suitable computer interface, the operator 160 may then select a geographic location 150. The geographic location 150 may, for instance, be selected by the operator 160 making an entry such as, but not limited to, a name of a town or place, a zip or postal code, coordinates of latitude and longitude, the name of an event, or some combination thereof.

Once the proprietary website 130 has received a selected geographic location 150, it may transmit a representative map 170 of the geographic location 150 back to the video display device 110 via the Internet connection 140.

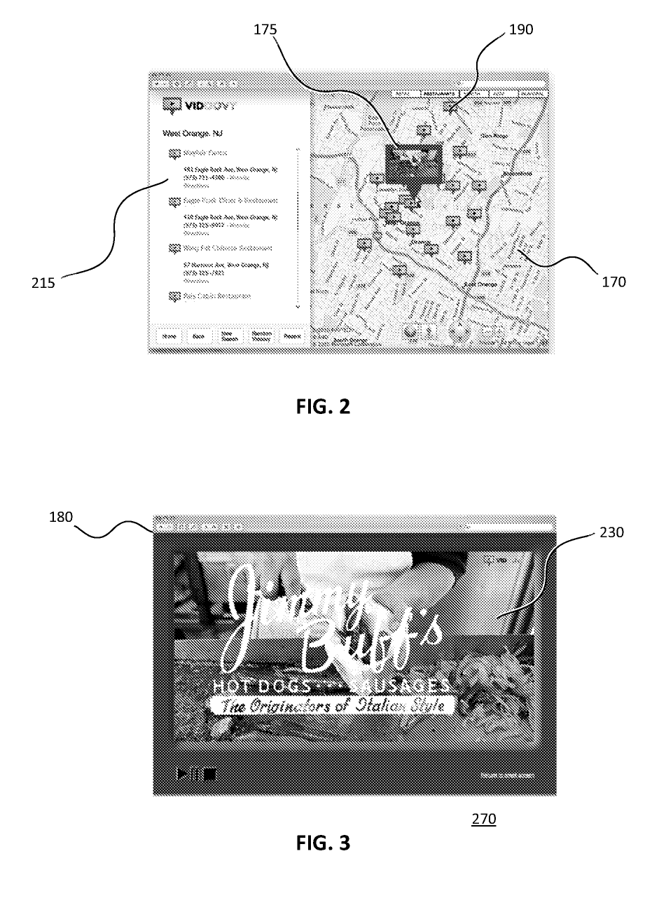

FIG. 2 shows a schematic view of a page being presented by the web browser software package 120 on the video display screen 180 attached to the video display device 110. The web page may display the representative map 170 overlaid with entity markers 190. The entity markers 190 may be indicative of the availability of an informational video related to a place of interest. In a preferred embodiment, the entity markers 190 are displayed on the representative map 170 at a position corresponding to the geographic location of the place of interest referenced by the entity marker 190.

The entity markers 190 may be any suitable graphic element such as, but not limited to, a flag, a geometric shape, an arrow, a triangle indicative of the “play” button on a video displayer, a TV screen like icon, or some combination thereof.

The entity marker 190 may include a preview of a place of interest 175 in the form of an image or other graphic. The preview of a place of interest 175 may, for instance, be activated when the user first interacts with the entity markers 190 by an action such as, but not limited to, a mouse-over, i.e., when a cursor is moved over the entity markers 190, by a single touch of the entity marker 190 on a touch screen display, or some combination thereof.

The display of the representative map 170 by the web browser software package 120 may also include a list of names 215 that may correspond to the entity markers 190. The list of names 215 of the places of interest may include additional information such as, but not limited to, an entity name, a phone number, a fax number, a web-page address, an email address, a street address, a FaceBook™ address, a Twitter™ address or some combination thereof.

The list of names 215 may occur in any suitable place on the web-page, or on a separated web-page such as, but not limited to, along the side of the representative map 170, beneath it, or above it, or some combination thereof.

In a preferred embodiment, the entity markers 190 shown when a geographic location 150 is selected may include a deliberately diverse group of entities. This diversity may be a means of aggregating an audience for new or different enterprises. For instance, in a preferred embodiment, the overlaid entity markers 190 may include at least the nearest of each of the following entities: an automated teller machine (ATM), a gas station, a source of food and drink, a medical facility, an educational facility and a public building. In this way, a user may quickly locate useful items and at the same time be exposed to places of interest in the geographic locality that they may not previously have been aware of.

In order to show the nearest example of one of each of this group of entities, the web browser software package 120 may need to adjust the scale of said representative map 170 so that all of said entity markers may be displayed simultaneously with each of the entity markers displayed at substantially the position on the representative map that corresponds to the physical location the entity.

FIG. 3 shows a schematic view of a frame of an informational video accessed via the method of this invention shown in full screen mode 270.

The informational video 230 may be streamed from the proprietary website 130 via the Internet connection 140 to the video display device 110 and displayed on the video display screen 180 by the web browser software package 120, provided the Internet connection 140 has sufficient bandwidth, and the video display device 110 has a sufficiently powerful central processing unit (CPU). A broadband speed of 2.5 Mbit/s or more is recommended for streaming standard quality video and at least 10 Mbit/s for high definition video. As the video and audio streams are typically compressed before transmission, the video display device 110 must have a CPU capable of performing decompression in near real time. The audio stream is typically compressed using an audio codec such as, but not limited to, a MP3, Vorbis or AAC, or some combination thereof. The video stream is typically compressed using a video codec such as, but not limited to, an H.264 or a VP8, or some combination thereof.

To begin playing the informational video 230, the operator 160 may select one of the entity markers 190. This selection may, for instance, be made by an action such as, but not limited to, clicking on the entity marker icon, mouseing over the entity marker icon, touching, or double touching the marker icon, or some combination thereof.

Once selected, the prerecorded informational video 230 associated with the selected place of interest may begin to be streamed and displayed. The operator 160 may interact with the displayed video using standard controls such as, but not limited to, a pause button, a stop button, a rewind button, a fast forward button, a volume control slider, a button for switching to a full screen mode 270 and an exit full screen mode button, or some combination thereof.

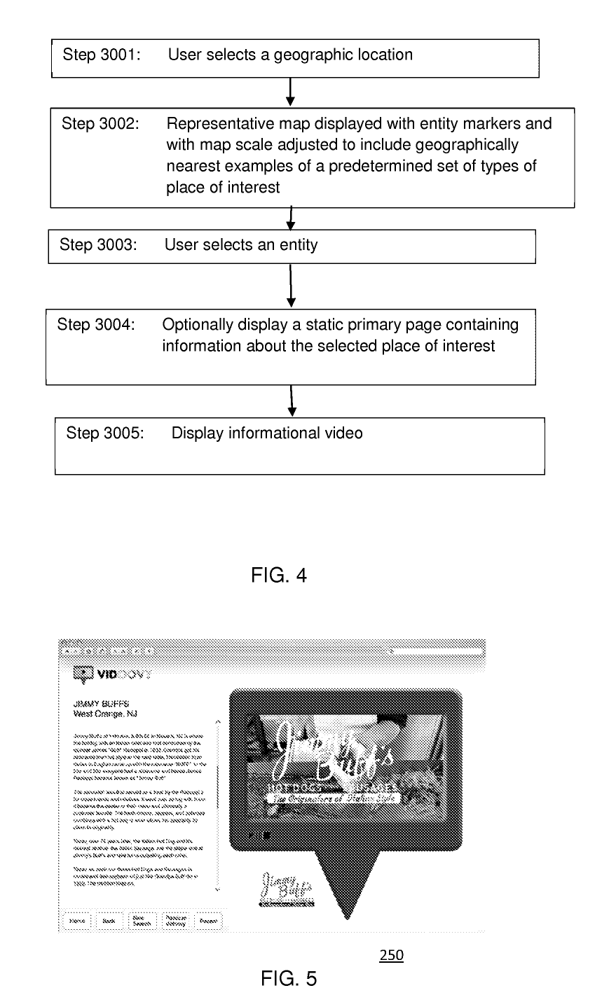

FIG. 4 shows a flowchart of some of the steps in using the method of this invention.

In Step 3001: User selects a geographic location: the operator 160 chooses a geographic location 150 of interest to them. This selection may be made by a method such as, but not limited to, a selecting from a drop down list of places, addresses or event names, entering a place name, an address, coordinates of latitude or longitude, a zip code or postal code, or some combination thereof.

In Step 3002: Representative map displayed with entity markers and with map scale adjusted to include geographically nearest examples of a predetermined set of types of place of interest: the proprietary website 130 sends a representative map 170 of the selected geographic location 150 to the web browser software package 120 running on the video display device 110. In addition, as described above, an overlay is provided that allows the web browser software package 120 to display a set of entity markers 190.

In a preferred embodiment, this set of representative entity markers 190 may include at least the nearest of each of the following entities: an automated teller machine (ATM), a gas station, a source of food and drink, a medical facility, an educational facility and a public building. In addition, the scale of the representative map 170 being displayed may be adjusted to ensure that all of this set of entity markers may be simultaneously displayed at a position on the representative map 170 that corresponds closely to their physical location.

In a further preferred embodiment, the set of representative entity markers may include more specific items such as, but not limited to, a hospital, a mail deposit box, a mall, a bank, a nail-salon, a hairdresser or a barber shop, a gym, a pizza restaurant, or some combination thereof.

In yet a further preferred embodiment, the operator 160 may be given an option to select a type of business, or the name of a business, or some combination thereof, to be displayed. This option may use a scroll down list, a set of on-screen search refinement tabs, or allow for user entry of names, or a combination thereof. The entity markers representative of the further selection may be displayed in addition to the entity markers 190 already being displayed, or they may be displayed instead of the entity markers 190 already being displayed.

In Step 3003: User selects an entity: the operator 160 may interact with the display of entity markers 190 in order to choose one. This interaction may take the form of any one of the well-known techniques for human-machine interfacing such as, but not limited to, pointing and clicking using a mouse controlled cursor, touching a touch-sensitive display screen 180 in at, or in vicinity of, the entity marker icon, or some combination thereof.

In Step 3004: Optionally display a static primary page containing information about the selected place of interest: the display of the selected informational video 230 may begin with the display of a primary, static page 250 (in FIG. 5). Displaying this page for a predetermined period of time such as, but not limited to, a time period of two to ten second, may allow decoding of a portion of the informational video 230 so that when it begins to display, there are no delays in presentation of successive frames of the video.

In a further preferred embodiment of the invention, the primary, static page 250 may serve as a preview, with the operator 160 being required to perform a further action, such as, but not limited to, clicking on a button, before the display of the streaming video commences.

In Step 3005: Display informational video: the informational video 230 is streamed to the video display device 110, decoded, and displayed on the video display screen 180 by the web browser software package 120.

FIG. 5 shows an example of a first page of an informational video displayed in accordance with the method of this invention.

The primary, static page 250 may, for instance, display more detailed audio visual information about the place of interest selected by choosing a particular entity marker.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A method for community asset mapping through a geographically-referenced display of informational videos, comprising:
providing a video display device running a web browser software package that is connected to a proprietary website via an Internet connection;
selecting a geographic location using said video display device by an operator;
displaying a representative map of said selected geographic location by said web browser software package on a video display screen connected to said video display device;
overlaying said representative map with a plurality of entity markers, each being indicative of a place of interest related to said geographic location, said entity markers including the geographically nearest to said geographic location of at least one ATM, one gas station, one source of food and drink, one health facility, one educational facility and one public or municipal building;
adjusting, by said web browser software package 120, the scale of said representative map such that all of said entity markers are displayed simultaneously and each of said entity markers is displayed at substantially the position on said representative map that corresponds to a physical location said place of interest of which said entity marker is indicative;
selecting by said operator, one of said entity markers; and
displaying an informational video on said video display screen containing information relevant to said selected place of interest of which said entity marker is indicative.

2. The method of claim 1, wherein selecting a geographic location comprises said operator entering at least one of an area code, a zip code and a city name, or a combination thereof.

3. The method of claim 2 further comprising displaying, on an initial selection by said operator, a preview of said place of interest of which said entity marker is indicative, and wherein selecting by said operator requires a further operator action before displaying said informational video.

4. The method of claim 3, wherein said initial selection comprises a mouse roll-over.

5. The method of claim 1 further comprising a list of names corresponding to said displayed entity markers, said names including at least an entity name, a phone number and a web-page address of said place of interest of which said entity marker is indicative.

6. The method of claim 1 further comprising, prior to displaying said informational video, displaying a primary, static page for a predetermined length of time, said primary, static page being indicative of place of interest of which said entity marker is indicative.

7. The method of claim 6, wherein said predetermined length of time is between 2 seconds and 10 seconds in temporal duration.

8. The method of claim 7, wherein said primary, static page further comprises an option for the operator to elect to display said informational video in a full screen mode.

9. The method of claim 1, wherein said displayed representative map further comprises said operator to select to display further entity markers by selecting a business type or a business name, or some combination thereof.

10. The method of claim 9, wherein said entity markers representative of said further selections are displayed in addition to said plurality of entity markers already displayed.

11. The method of claim 9, wherein said entity markers representative of said further selections are displayed instead of said plurality of entity markers already displayed.

12. The method of claim 1, wherein said initially displayed entity markers further includes at least one indicative of a place of interest corresponding to one of a hospital, a mail deposit box, a mall, a bank, a nail-salon, a hairdresser or a barber shop or some combination thereof.
